(19) United States
(12) Patent Application Publication
(10) Pub. No.: US 2015/0355378 A1
(43) Pub. Date: Dec. 10, 2015

(54) LAYERS OR THREE-DIMENSIONAL SHAPED BODIES HAVING TWO REGIONS OF DIFFERENT PRIMARY AND/OR SECONDARY STRUCTURE, METHOD FOR PRODUCTION THEREOF AND MATERIALS FOR CONDUCTING THIS METHOD

(71) Applicant: FRAUNHOFER-GESELLSCHAFT ZUR FÖRDERUNG DER ANGEWANDTEN FORSCHUNG E.V., München (DE)

(72) Inventors: Herbert Wolter, Tauberbischofsheim (DE); Ruth Houbertz-Krauss, Wuerzburg (DE)

(73) Assignee: FRAUNHOFER-GESELLSCHAFT ZUR FÖRDERUNG DER ANGEWANDTEN FORSCHUNG E.V., Munchen (DE)

(21) Appl. No.: 14/760,081

(22) PCT Filed: Jan. 13, 2014
(86) PCT No.: PCT/EP2014/050514

§ 371 Date: Jul. 9, 2015

(30) Foreign Application Priority Data
Jan. 11, 2013 (DE) 10 2013 100 313.3
May 6, 2013 (DE) 10 2013 104 600.2

(51) Int. Cl. G02B 1/04; B29C 67/00; C09D 143/04; C08F 230/08; C08J 9/00

(52) U.S. Cl. CPC G02B 1/045; C08F 230/08; C08J 9/00; C09D 143/04; B29C 67/0066; C08J 2343/04; B29K 2083/00

(57) ABSTRACT

The invention relates to a layer or a three-dimensional molded article comprised of or composing an organically modified polysiloxane or a derivative thereof, the silicon atoms of which are completely or partially replaced with other metal atoms, wherein the organic share of the polysiloxane or derivative thereof has an organic cross-link with (i) C═C addition polymers and/or thiol-ene addition products bonded to silicon and/or to other metal atoms via carbon and/or oxygen, which are obtainable via a two-photon or multi-photon polymerization reaction, as well as with (ii) organic molecules integrated into the organic cross-link copolymerized via C═C double bonds or through a thiol-ene addition to double bonds or to SH groups of an organic radical, wherein the article has two areas with differing primary and/or secondary structures, available through the following process:
a) Providing a substrate or a mold,
b) Providing a material selected from sols, gels, and organically modified materials containing polysiloxanes, all of which contain metal and/or metalloid, wherein said provided material has the following components:
   (i) At least one oligomer or polymer containing metal or metalloid having groups that are polymerizable via a two-photon or multi-photon polymerization reaction, for which the formation of either C═C addition polymers and/or thiol-ene addition products is possible, wherein at least a part of these groups is present bonded to said oligomers or polymers containing metal or metalloid via a carbon atom or an oxygen bridge, and
   (ii) At least one organic monomer containing at least one radical, which is available to either the same two-photon or multi-photon polymerization as the groups of the oligomers or polymers containing metal or metalloid pursuant to (i) or which can be photochemically copolymerized with these radicals or can be added to them,
c) Applying or attaching the provided material on or to the substrate or pouring it into the mold,
d) Selective exposure of a selected area of material located on the substrate or in the mold with the help of two-photon or multi-photon polymerization,
e) Thermal or photochemical treatment of the entire material located on the substrate or in the mold,
   with the provision that steps d) and e) can be conducted in any sequence, as well as the respective method.

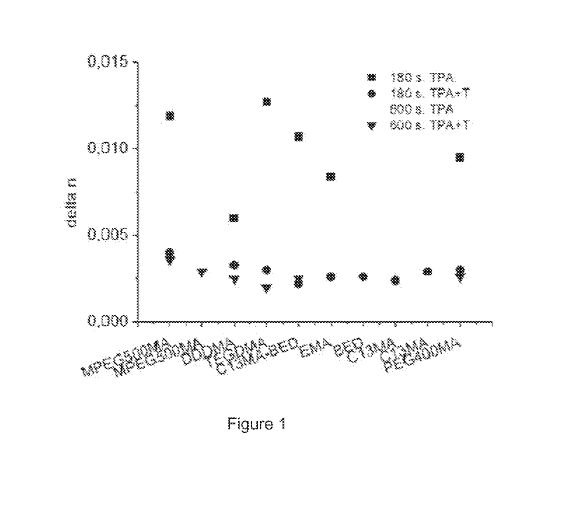

The present invention relates to special layers or three-dimensional molded articles produced from only one material having sections with differing primary structures (i.e. chemical connections, e.g. influencing the degree of cross-linking or based on rearrangements or repositioning) and/or secondary structures (in the present case, this refers to the order of the molecules in the molded article compound, which is influenced, e.g. through folds or compactions). Said varying primary and/or secondary structure of the different sections causes them to have differing physical or mechanical properties, for example different refractive indices or a different module of elasticity. In one specific embodiment, there is an initial section with cross-linked structures, while a second section still (at least organically) has the material in a non-cross-linked state. This may be subsequently washed out (“development” of the structure produced through cross-linking), such that a two-dimensional layer or a three-dimensional molded article can be formed with only one primary or secondary structure, though with specific forms. In this manner, for example, porous molded articles or structured layers can be produced without mask processes being necessary for the latter. Furthermore, the invention relates to processes for the production of these layers or molded articles.

The production of three-dimensional articles by irradiating predetermined voxels in a bath material with the aid of two-photon polymerization (2PP) has been known for some time. Initial attempts were successful with purely organic materials. WO 03/037606 A1 describes the production of three-dimensional articles comprised of polysiloxanes, which can be produced through the hydrolytic condensation of silanes with organic groups that are bonded via Si—C and capable of polymerization by means of radiation. The basis for the polymerization process presented there is two-photon polymerization (also called 2PP) induced through two-photon absorption (also called TPA), wherein it was possible to determine that the cross-section (the probability of 2P absorption) of the organic polysiloxanes was large enough to use this process for producing three-dimensional structures, whether in the form of (potentially self-supporting) articles or surface structures or other layers that are potentially held by a substrate. A lithographic resolution of approx. 100 nm by means of femtosecond laser irradiation, which, however, had not yet been optimized, is mentioned in WO 03/037606 A1.

A number of publications have since been devoted to this topic; to a large degree, the process removed and refined previously conventional stereolithography through its high resolution, smallest structures in the range of 100 nm or smaller, and the very high finish quality achievable in the process. Using two-photon polymerization enables the production of, for example biocompatible, bioresorbable or biodegradable structures, which can be used as scaffolds for linking living cells or for implants. These materials can also be based on respectively modified polysiloxanes—see WO 2011/98460 A1. Additional suggestions relate to the selective exposure of hydrogels comprised of methacrylated poly(ε-caprolactone)-based oligomers or poly(ethylene glycol)diacrylate by means of 2PP—Jenni E. Koskela et al. in Polym. Adv. Technol. 23, 992-1001 (2012). Another approach is revealed in WO 2011/147854 A1. This publication deals with the production of structured molded articles as well as thin or even thicker layers of organometallic compounds capable of being organically cross-linked through photochemical processes, from which technically relevant oxidic function bodies or layers can be produced, e.g. in the form of magnetic or piezoelectric active sensors or actuators or (energy) converters, such as ultrasound transducers comprised of LZT (lead zirconate titanate) or BTO (barium titanate), through sintering and potentially subsequent physical activation, for example polarization with the aid of an electric field, or, if magnetic materials are contained therein, activation through a magnetic field.

In all the aforementioned cases, the three-dimensional article or the structured surface is developed due to the fact that non-exposed bath material is washed out.

There are cases, in which the article manufactured in this manner is intended to be embedded in another material, which has other physical properties. One prominent example for this is the production of waveguides that have to be embedded in cladding as a “core” in order to affect the refractive index difference between the medium of the waveguide itself and the adjacent medium. Due to the fact that polymerized polysiloxanes normally have a high transmission rate for visible light and adjacent areas as well, they are potential candidates for such waveguides. In this regard, it should be noted that the entire range from UV to IR is of interest—materials transmitting in the visible or very close infrared range are suitable, e.g. for multi-mode waveguides (a wavelength, e.g. of 850 nm is used) as well as utility articles; single-mode waveguides that are used in the area of data transmission frequently use the wavelength 1310 and 1550 nm. UV light is used in blue ray (DVD) players. The smaller the wavelength used, the denser, finer structures can be produced, which in the context of data carriers means that they can record more data on the same surface than written with larger wavelengths.

Today, waveguides are still produced in part through “classic” exposure. Thus, e.g. in Optics Express 20 (6), 6575-6583 (2012), Chunfang Ye et al. suggest producing waveguides through directly inscribed lithography. Photopolymers that were developed for holographic data storage serve as the basis for them. These photopolymers comprise a solid, though flexible matrix as well as photoactive components, namely a suitable photoinitiator and a monomer that polymerizes through a reaction with the excited initiator. Local exposure of the materials causes the resulting polymer accumulates in the exposed areas, while its concentration decreases in the non-exposed areas due to diffusion processes. The authors consider this to be the cause for a local increase of the refractive index. After completion of selective exposure, the entire material is exposed in order to “consume” the remaining initiator and remaining monomer, and a material that is no longer chemically or optically reactive, the optical properties of which differ in the selectively exposed areas from the non-selectively exposed areas. Both areas could be used as a “core” and “cladding” of a waveguide.

There have also been attempts to use 2PP for similar processes. In the Journal of Laser Micro-Nanoengineering 6 (3), 195-198 (2011), J. Kumpfmüller et al. suggest using a silicone polyether acrylate resin as a basis, which was made in a thixotropic manner with the help of a rheology additive. Trimethylolpropane triacrylate and a photoinitiator were added to this mixture. Based on phase contrasts, the authors were able to demonstrate the production of structures that could be suitable as waveguides. This group also assumes that the various properties of the differently exposed material are based on the diffusion of the monomer. However, a thixotropic material is unsuitable as the “cladding” of a waveguide as it is not mechanically stable and the optical quality is frequently too low.

In Optical Materials 34 (2012) 772-780, S. Bichler, S. Feldbacher, R. Woods, V. Satzinger, V. Schmidt, G. Jakopic, G. Langer, W. Kern manufactured a material, the matrix of which was produced by reacting a hydridosilane with a vinyl silane by means of classical hydrosilylation (in the presence of a platinum catalyst). Benzyl methacrylate or phenyl methacrylate served as monomers, which were chosen due to their high refractive index. Ethylene glycol dimethacrylate served as a cross-linking agent for the photo-induced polymerization. Irgacure 379 was used as a photoinitiator. In the first step, the material was heated, wherein the siloxane matrix formed, in which the monomeric material was present in a dissolved state. A selective 2PP exposure was then conducted to produce optical waveguides, the finally the non-reacted monomer was extracted from the area of the non-exposed matrix through vacuum extraction in order to stabilize it. The photo-induced polymerization reaction of the methacrylate monomers was observed with the aid of FT-IR spectroscopy and phase contrast microscopy. The hydrosilylation used for the production of the matrix resulted in silicone rubber, such that the produced waveguide structures as well as the surrounding matrix were flexible.

There is still a need for materials for producing structural cross-links capable of having random shapes, for example being nano-structured or micro-structured, which can be used, e.g. in the area of 3-D optical interconnects or based on areas with a differing modulus of elasticity, and which have areas with differing primary and/or secondary structures (as defined above) within a molded article produced from a single material. In particular, there is a need for materials, with which solid, stable structures can be produced in a very simple manner having varying physical properties (for example optical or mechanical) within their structure (i.e. within the solid object, of which the structure is composed).

Surprisingly, the inventors of the present invention were able to determine that a workaround can be developed in this case, namely through the recommendation of providing a material containing polysiloxane modified with an organic radical that is polymerizable via 2PP or multi-photon polymerization or a sol or a gel having a metal coordination complex modified with an organic radical that is polymerizable via 2PP or multi-photon polymerization, which always contains an organic monomer having groups that can be polymerized into the resulting polymer with 2PP or multi-photon polymerization, and subjecting this material to (locally) selective 2PP and overall to a thermal and/or photochemical process step or a wash cycle, wherein the first of the mentioned steps is conducted prior to or after 2PP or multi-photon polymerization.

Surprisingly, the inventors were able to determine namely that a selectively exposed structure emerges embedded in a fully solidified material or in the direct vicinity thereto upon using this material and this process sequence, wherein the selectively exposed area features structural changes compared to a non-selectively exposed area, such as a differing primary and/or secondary structure, as described above, including possibly or in some cases a higher cross-linking of organic components in the selectively exposed area. The fact that the photochemical process step may comprise an exposure up to beyond the saturation limit of the 2PP or multi-photon polymerization process and that an exposure of the entire material may instead or additionally occur prior to the selective exposure, however, suggests that the differences are not necessarily variations in the degree of cross-linking of the organic network, but rather that effects such as reordering processes, rearrangements or compactions (e.g. while relieving stress) play a role, which possibly result in an inorganic network (i.e. the formation of higher molecular units), although the material—provided that it is produced according to the sol-gel process—had already previously reached the maximum degree of condensation possible under the selected conditions. These structural variations result in differing physical properties. The selectively exposed structure can thus have a refractive index, which conveniently differs from that material of the surrounding or adjacent, completely solidified material and is particularly higher, such that the formed structure can be used, e.g. as the “core” and “cladding” of exposed waveguides, or both areas may have varying mechanical properties, such as different elastic moduli or strengths.

In the following, the term “2PP” is not merely intended to encompass two-photon polymerization, but rather polymerization reactions as well that occur through absorption of more than two photons, thus so-called multi-photon polymerization (MPP). 2PP or multi-photon polymerization is triggered by 2PP or multi-photon absorption, called TPA (two-photon absorption) or MPA (multi-photon absorption). However, the use of the term TPA in the following should always imply that MPA is included.

If the term “(meth)acryl” is used in the following, this either refers to the methacryl group and/or the acryl group. The same applies for the terms “(meth)acrylate”, “(meth)acrylamide”, and “(meth)acrylthioester”.

A multitude of partially known materials can serve as a modified material containing polysiloxane or as a sol or gel having a metal coordination complex modified with an organic radical that is polymerizable via two-photon or multi-photon polymerization. It is necessary that the material has groups that are polymerizable via TPA or MPA, wherein the formation of addition polymers comprised of structures containing C═C double bonds alone as well as of thiol-ene addition products is possible. If the material has non-aromatic C═C double bonds, e.g. isolated double bonds, such as vinyl groups, or in allyl or styryl groups or in α,β-unsaturated carbonyl compounds, a polymerization reaction (addition polymerization or chain growth polymerization) may occur between the C═C groups under the conditions of TPA. Furthermore, isolated double bonds can be charged thiol groups under these conditions, namely even those that are not available for polymerization of the C═C bonds alone due to a potential steric hindrance or for other reasons, e.g. norbornenyl groups. Even some ring systems, e.g. tensioned rings, can be subjected to TPA, e.g. systems containing epoxy groups, wherein these are polymerized in a cationic manner, while the C═C polymerization and thiol-ene addition reactions above occur radically. All of these groups should fall under the concept of “organic groups that are polymerizable via two-photon or multi-photon polymerization”. These groups are referred to as “organic groups that are polymerizable via two-photon or multi-photon polymerization” in those materials, in which the mentioned groups are already subjected to TPA.

The inventors determined that at least one part of the groups capable of forming polymers via TPA should be bonded to an oligomer or polymer containing metal or metalloid for the suitable materials, wherein the radicals that have the mentioned groups can be bonded to the metal potentially via an oxygen bridge. However, bonds via a carbon atom are preferred, and particularly preferred is the bond to a silicon atom via a carbon atom in the compound of an organically modified polysiloxane or silicic acid (hetero)polycondensate. The effects determined now for the first time are possibly based on the fact that the organically polymerizable components in the material used pursuant to the invention are integrated into the inorganic cross-link as a result of bonding to the respective metals/metalloids and therefore cannot form a cross-link separate from the inorganic cross-link.

Thus, pursuant to the invention, a layer or a three-dimensional molded article is provided comprising a material containing organic radicals polymerized via two-photon or multi-photon polymerization, wherein at least one part of the groups, which can form polymers via TPA, is bonded to the metal/metalloid of an oligomer or polymer containing metal or metalloid via an oxygen bridge and/or via a carbon atom, wherein said article has two areas that are structurally, i.e. with respect to their primary structures or secondary structures (as defined above) different and at the same time preferably have different degrees of cross-linking and/or different refractive indices and/or elastic moduli, available through the following process:
a) Providing a substrate or a mold,
b) Applying a material containing organic radicals polymerized via two-photon or multi-photon polymerization, wherein at least one part of the groups, which can form polymers via TPA, is bonded to the metal/metalloid of an oligomer or polymer containing metal or metalloid via an oxygen bridge or via a carbon atom, onto the substrate or pouring it into the mold,
c) Selective exposure of a selected area of material located on the substrate or in the mold using two-photon or multi-photon polymerization,
d) Thermal or photochemical processing of the entire material located on the substrate or in the mold,
   wherein the sequence of steps c) and d) can be selected randomly.

In one series of embodiments, it is simultaneously preferred to harden the entire material according to step d) after selective exposure was conducted.

In a preferred embodiment, the material is a polysiloxane or silicic acid (hetero)polycondensate pursuant to (b).

Examples of these polysiloxanes or silicic acid (hetero)polycondensates are revealed in WO 03/037606 A1, i.e. polysiloxanes that are obtainable through hydrolysis and at least partial condensation of a starting material, which has at least one silane of a formula (I),

R¹ₐR²_{b}SiX_{4-a-b} (I)

wherein R¹ is equal or different and represents an organic radical polymerizable via two-photon or multi-photon polymerization, R² is equal or different and refers to an organic radical not capable of being polymerized in this manner, and X is a radical that can be hydrolyzed out of silicon under hydrolysis conditions, the index a represents 1, 2 or 3, the index b represents 1 or 2, and a+b together are 1, 2 or 3. Radicals containing C═C double bonds are primarily, though not exclusively suitable as radicals R¹, including in particular radicals in addition to vinyl or allyl radicals having an α,β-unsaturated carbonyl compound, as well as ring systems and, in particular, condensed ring systems containing double bonds, such as the norbornenyl radical and derivatives thereof having, for example, one of the following structures:

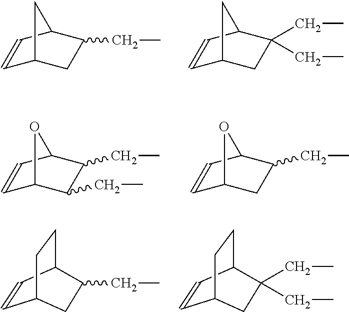

Instead or additionally, for example, sols or gels can be used that were obtained through the following steps: (a) Dissolving at least one compound of one or more metals selected from magnesium, strontium, barium, aluminum, gallium, indium, silicon, tin, lead, and the transition metals in an organic solvent and/or replacing a ligand of the or of one of the dissolved metal compound(s) with a stabilizing ligand, (b) Adding a ligand to the solution, which has at least one photochemically polymerizable group and at least one such group that enables a stable complex formation with the respective metal atom, and developing a sol with or from the product of this reaction (precursor), wherein said photochemically polymerizable group has the same meaning as radical R¹ in the silane of the aforementioned formula (I). These sols are revealed in WO 2011/147854 A1.

The production of organically modified polysiloxanes or silicic acid condensates (frequently also referred to as “silane resins”) and their properties has been described in a number of publications. As a representative of this, reference is made, for example, to Hybrid Organic-Inorganic Materials, MRS Bulletin 26(5), 364ff (2001). Broadly spoken, such substances are normally produced with the help of the so-called sol-gel method, in which hydrolysis-sensitive, monomeric or pre-condensed silanes are subjected to hydrolysis and condensation, potentially in the presence of additional co-condensable substances, such as alkoxides of boron, germanium or titanium, as well as potentially additional compounds, which can serve as modifiers or cross-link converters, or other additives, such as fillers. Materials that are suitable for the present invention are, for example, specified in DE 4011 044C2, DE 196 27 198, EP 450 624 B1, EP682 033 B1, EP 1 159 281 B1, EP 1 685 182 B1, EP 1 874 847 B1, EP 1 914 260 A1, WO 2003/037606 A1, WO 2011/098460 A1, and WO2011/141521. These materials are distinguished by the fact that they have radicals bonded to silicon via carbon, which have one or more groups R¹ that are organically polymerizable via 2PP (TPA). Acryl and methacryl groups are or may be present in most of these materials, which correlate to the aforementioned radical R¹; alternatively, e.g. norbornenyls as well as homologs or other condensed systems containing double bonds, such as vinyl, allyl or styryl groups, are suitable as a radical R¹. With respect to the usable norbornenyl silanes and applied compounds, we can also refer to the previously aforementioned DE 196 27 198 A1. Thus, the norbornene ring can naturally be potentially substituted; even a bicyclo[2.2.2]octane radical can be present instead of the norbornene radical (i.e. the bicyclo[2.2.1]heptene radical). Furthermore, the five-membered ring of the condensed system containing double bonds can contain an oxygen atom if the (meth)acryl group is reacted with furan instead of cyclopentadiene.

The aforementioned list, however, should not be considered to be final, which can be seen in the following explanations.

Pursuant to the invention, silicon-based resins/paints can also be used in particular, such as is described in WO 93/25604 or in DE 199 32 629 A1. Among these, the modified silicic acid polycondensates from DE 199 32 629 A1 are preferred as they are produced using silane diols as well as alkoxy silanes, wherefore the condensation of the silane compounds occurs for the exclusive formation of alcohol, though not of water. Very particularly preferred are co-condensation products of the compounds Ar₂Si(OH)₂ and R¹Si(OR′)₃, wherein Ar is an aromatic radical having 6 to 20 carbons, in particular potentially substituted aryl and very particularly preferred an non-substituted phenyl radical bonded directly to silicon, and R¹ has the meaning specified for formula (I) and preferably at least one epoxy group or one C═C double bond, particularly having a double bond available for Michael addition (e.g. it is a (meth)acrylate group). Very particularly preferred, R¹ in this combination is a methacryloxy-alkyl, e.g. a methacryloxy-propyl group. Co-condensation products, in which Ar₂ and/or R₁ represent styryl groups, are possible. The production of a silane condensate from a mixture of diphenyl silane diol and 3-Methacryloxypropyltrimethoxysilane and in the molar ratio of 1:1 is described in example 1 of DE 199 32 629 A1 mentioned above; the selected ratio leads to the fact that hydrolysis occurs through the exclusive use of catalytic amounts of water. Thus, materials can be produced that have a low absorption rate at 1310 and 1550 nm in the field of telecommunication due to the lack of oscillations of the OH group.

It is preferred that TPP or MPP is conducted via one or more groups that can be radically polymerized. Although these systems are also suitable pursuant to the invention, which can be polymerized with the help of cationic UV starters, for example, ring-opening systems, such as epoxy systems (see e.g. C. G. Roffey, Photogeneration of Reactive Species for UV Curing, John Wiley & Sons Ltd, (1997)), they tend toward parasitic polymerization, i.e. polymerization also occurs in the non-exposed areas, wherefore they are less well-suited for applications involving extreme requirements for fineness and smoothness of the surface, e.g. high-resolution lithography.

Preferably, the radical R¹ in formula (I) above contains one or more non-aromatic C═C double bonds, particularly preferably double bonds available for Michael addition, e.g. α,β-unsaturated carbonyl compounds. These can be acryl or methacryl groups, particularly in the form of (meth)acrylate, (meth)acrylamide, and (meth)acrylthioester. R² can potentially be a substituted alkyl, aryl, alkylaryl or arylalkyl group, wherein the carbon chain of these radicals can be broken potentially through O, S, NH, CONH, COO, NHCOO, or similar. In this context, R² can also contain groups that can undergo an addition reaction with C═C double bonds, or contain a group relevant for biological purposes as revealed in WO 2011/98460 A1. The group X is normally hydrogen, halogen, alkoxy, acyloxy or NR³₂ with R³ equal to hydrogen or lower alkyl. Alkoxy groups are preferred as hydrolysable groups, particularly lower alkoxy groups, such as C₁-C₆-Alkoxy.

The organopolysiloxane capable of solidification can be produced using at least one additional silane of a formula (II),

SiX₄ (II)

wherein X is equal or different and has the same meaning as in formula (I). A compound that can be used well for this purpose is tetraethoxysilane. By adding these silanes to the mixture to be hydrolyzed and condensed, from which polymerizable bath material is finally produced, the SiO percentage of the resin, i.e. the inorganic percentage, is increased. Thus, the absorption of the resin into the wavelengths of interest can be reduced.

Conversely, the silane polycondensate to be organically polymerized may have been produced using at least one silane of a formula (IV),

R¹ₐSiR²₄₋ₐ (IV)

wherein R¹ and R² have the meaning specified above for formula (I). Thus, the degree of cross-linking of the polycondensate is reduced.

Furthermore, R¹ can be an organic radical polymerizable via two-photon or multi-photon polymerization that is different than R¹ of formula (I).

The mixture, from which the silane condensate is produced, may still contain a silanol of a formula (III),

R⁴ₐSi(OH)₄₋ₐ (III)

wherein R⁴ can be the same or different and respectively has the meaning of R¹ as defined in formula (I) or of R² as defined in formula (I), and wherein the index a represents 1, 2 or 3, preferably 2. Hydrolysis may therefore occur in the presence of these compounds with the help of catalytically effective amounts of water; incidentally, the system can remain free of water. In one preferred design of the invention, disilanols of said formula (III) are used with silanes of said formula (I), which preferably contain a group R¹, in a mixture ratio of 1:1 (mol/mol) as starting material to be hydrolyzed and condensed.

If R¹ carries a C═C double bond in formula (I) and R² is not present in this formula or has no functional groups, in one specific design, at least one silane of a formula (V) can be added to the material to be hydrolyzed and condensed,

R³ₐSiX₄₋ₐ (V)

wherein R³ carries a group, which can be added radically to a C═C double bond, particularly a thiol group. Respective condensates are then available for polymerization through addition reactions of the groups R³ of silanes of said formula (V) to double bonds of the radicals R¹ of silanes with formula (I).

The mixture to be hydrolyzed and condensed for the purposes of the present invention can contain additional substances, e.g. preferably lower alkoxides, particularly C₁-C₆ alkoxides, of metals of the third primary group, of germanium, and of metals of the second, third, fourth, fifth, sixth, seventh, and eighth sub-group.

Overall, the organically modified silicic acid polycondensate, from which the articles can be produced pursuant to the invention, should preferably have at least 0.1 mol of groups available for 2PP or MPP (R¹ of formula (I)), with respect to the molecular volume of silicon atoms, plus potentially the metal atoms of the third primary group, of germanium, and the second, third, fourth, fifth, sixth, and seventh sub-group, if present.

The material, which is solidified on the specified substrate or in the specified mold, contains additionally free organic monomers. In a first variation of the invention, these monomers are available to the same two-photon or multi-photon polymerization as the radicals R¹ on the (pre-condensed) silanes of formula (I). In one preferred embodiment, this involves the same radicals R¹.

In a more preferred embodiment, the organic monomers are selected from monomers, which the help of which the silanes of formula (I) were produced. Particularly favorable in this case are acryl and methacryl compounds, such as (meth)acrylates.

Trimethylolpropane triacrylate (TMPTA) or dipentaerythritol pentaacrylate are specified as examples, which, for example, can be reacted with a trialkyoxysilane or with a mercaptoalkylalkyldialkoxysilane or with a mercaptoalkyltrialkoxysilane as explained in DE 4011044 C2. The use of a molar surplus of (meth)acrylate molecules with regard to the hydrido or mercapto groups of said silane leads to a sol or gel containing a polysiloxane, which contains (meth)acrylate molecules, following hydrolytic condensation of the silane.

However, in an alternative embodiment, the monomeric, organically polymerizable compounds may also be different compounds than those used for the production of the silanes. In this regard, those monomers capable of being photochemically co-polymerized with radicals R¹ of the siloxanes can be selected. They react partially with themselves when subjected to irradiation and partially with the organically polymerizable groups of the polysiloxane. The following are examples of this:
1,12-Dodecanediol dimethacrylate (DDDMA)
Tetramethylene glycol dimethacrylate (TGMDMA)
Triethylene glycol dimethacrylate (TEGDMA)
Ethyl methacrylate (EMA)
Tridecyl methacrylate (C13MA)
Variations of polyethylene glycol methyl ether-methacrylate (MPEG500MA)
Bisphenol-A-ethoxy diacrylate (BED)
Polyethylene glycol-dimethacrylate (PEG400DMA)
Triethylene glycol triacrylate
Trimethylolpropane triacrylate (TMPTA)

These monomers are selected in consideration of the fact that they have different polarities in a molecule, a different number of polymerizable groups, particularly methacryl or acryl groups, and, in the case of more than one polymerizable group, different chain lengths between two polymerizable groups. If monomers having more than one polymerizable group are selected, more dense organically-linked cross-links develop. Mechanical properties, such as elasticity or modulus of elasticity and the like, can be set with the chain length.

However, those monomers that form the other reactions may also be selected instead. Monomers, for example, which react with a radical R¹ of the silane differently than through a polymerization reaction, are suitable for this. One example is the reaction of a monomer, which has one (or more) thiol groups, for example, with a (meth)acryl group of the polysiloxane.

The following are examples of suitable thiol compounds:
Trimethylolpropane tri(3-mercaptopropionate) (TMPMP)
Trimethylolpropane trimercaptoacetate (TMPMA)
Pentaerythritol tetra(3-mercaptopropionate) (PETMA)
Pentaerythritol tetramercaptoacetate (PETMA)
Glycol dimercaptoacetate
Glycol di(3-mercaptopropionate)
Ethoxylated tri methylolpropane tri(3-mercaptopropionate)
4,4-Thiobisbenzenethiol
4,4′-Dimercaptostilbene.

If thiol compounds are used as monomers, it is possible, though not necessary, that the polysiloxane has radicals containing C═C double bonds, which can undergo a polymerization reaction (chain growth polymerization, addition polymerization). However, it may be sufficient that the polysiloxane contains C═C double bonds, which are not available for this polymerization reaction due to steric or other conditions, provided they form a thiol-ene reaction with the thiol compound. The polysiloxane may itself, however, also contain, e.g. thiol groups, for example, through the incorporation of mercapto silanes into the polysiloxane cross-link, and in these cases, a monomer can be selected having C═C double bonds, which can be subjected to a thiol-ene reaction. In preferred cases, this monomer has (meth)acryl groups, more preferably methacryl groups, particularly methacrylate groups, wherein said methacrylate groups can then react partially with organically polymerizable C═C double bonds present on the polysiloxane in a photoinitiator-induced manner, partially with the thiol groups of the siloxane independent of the presence of a photoinitiator. These silanes, however, must not be necessary added prior to hydrolytic condensation; rather they can also be subsequently added as monomeric silanes. Examples of suitable thiosilanes are:
3-Mercaptopropyl trimethoxysilane
3-Mercaptopropyl triethoxysilane
3-Mercaptopropyl methyldimethoxysilane.

In this embodiment, it is even possible that the polysiloxane has absolutely no C═C double bonds available for an organic polymerization (chain reaction polymerization).

The volume of monomeric, organically polymerizable compounds is not critical; in a preferred manner, it is in the range of up to 0.5 mol, more preferably in the range of 0.1 to 0.3 mol per mol of silane used for the siloxane of the formula (I).

The organically-modified material contain polysiloxanes still contains a photoinitiator, at least if polymerization does not occur exclusively via a thiol-ene addition. This can be, for example, an initiator from the Irgacure product line, such as Irgacure 369, Oxe01 or Oxe02, or another initiator, such as Lucirin TPO and TPO-L. In particular, reference should be made to the initiators developed especially for two-photon and multi-photon polymerization, which act through hydrogen abstraction, e.g. Irgacure 369, DPD or N-DPD (1,5-Diphenyl-penta-1,4-diyn-3-on or the ortho-dimethylamino derivative thereof), see e.g. R. Liska et al. in Applied Surface Science 254, 836-840 (2007) and B. Seidl et al. in Macromol. Chem. Phys. 208, 44-54 (2007). Cationic initiators can also be used if the material containing polysiloxanes contains, for example, epoxide groups. If the polysiloxane has differing radicals R¹, e.g. methacrylate groups and epoxy groups, mixtures of radically-acting initiators with cationic-acting initiators are possible as well. Thus, this results in more precise control of the polymerization.

The photoinitiator is preferably added after the inorganic cross-linking of the material has already occurred through hydrolytic condensation of the silane(s) used. For this purpose, it is weighed in and introduced into the material formulation while stirring in yellow light (clean room conditions, yellow light laboratory). Subsequently, the material is ready for use, although it may not yet be filtered, if desired.

The quantity of photoinitiator to be added is not critical—it may be, e.g. in the range of between 0.1 and 5% by weight. 2% by weight is frequently favorable. If the system has double bonds, which cannot be activated, for example, in the form of norbornenyl groups, the quantity of initiator may however be selected significantly less. The photoinitiator may even potentially be left out, namely if thiol-ene links are to be formed, e.g. when reacting a polysiloxane containing norbornenes with a monomeric thiol.

To produce the functionality of three-dimensional molded articles with areas of a different cross-link structure, the material must be exposed. For this purpose, it is introduced onto a substrate or into a mold, wherein it can form a bath in the mold. This can occur through any method known in the state of the art, for example, applying a liquid or pasty material through spin-coating, with a squeegee, through dispensing, compression, submersion or spraying, but also through applying or potentially fastening a previously solidified material on or to a substrate or into or in the mold, wherein all conventional substrate and mold materials can be used, such as glass, silicon or metals, and the layer thickness can be selected fully variably, for example, between 100 nm and several mm. The substrate can be planar, but it can also have an uneven form; molded articles of any (even larger) dimension, particularly a relatively high dimension, can be produced, e.g. in the range of 1-10 mm.

The molded article is subsequently produced through a process comprising two steps. In one, the liquid or pasty or even solid material is selectively solidified on the desired, previously calculated areas, on which the structural change in the finished product is desired, e.g. on those locations that should have a higher refractive index in the finished product, with the help of a laser, preferably an ultra-short pulse laser. For this purpose, a laser beam is directed toward each volume element to be solidified. Radiation with femtosecond laser pulses is particularly suited for this. In principle, solid-state lasers, diode-pumped solid-state lasers, semi-conductor lasers, fiber laser, etc. of any wavelength can be used as a beam source. An Ytterbium laser system is used with particular benefit in one embodiment of the invention. Upon doubling the frequency, its wavelength is in the range of green light. The benefit of Ytterbium lasers compared to titanium-sapphire laser systems, which have a wavelength of approx. 800 nm (wherein, however, the second harmonic can be used at 400 nm), is the wavelength of 1030 nm. Upon doubling the frequency, it is in the green range at 515 nm, which can lead to an improved resolution. Moreover, the materials to be structured can be processed more efficiently than with lasers in wavelength ranges of approx. 800 nm. The process window is significantly larger with respect to material formulations. The benefit of Ytterbium laser systems lies in the fact that these lasers can be pumped with diodes no additional pump laser or various other instruments are necessary. Relatively short pulses constitute the advantage of Ytterbium lasers compared to Nd:YAG lasers. Other short-pulse lasers can also be used in the method pursuant to the invention, particularly fiber lasers. When using larger wavelengths, polymerization can also be initiated by means of n-photon absorption, wherein n is larger than 2. The threshold fluence, at which the polymerization process starts, can be reduced through the selection of suitable components, e.g. co-initiators and/or amine components, with an increased multi-photon absorption cross-section in the resin. Thus, the process window, in which polymerization occurs, becomes enlarged although the material is not yet destroyed. Naturally, the hardened material must be transparent for the laser wavelength used.

The shape and design of the selective range can be freely selected. In some cases, it is beneficial to select a base point on the substrate or on the mold, from which the solidifying structure extends. However, this is not a necessary measure; rather, the structure can be freely written into the material, namely—surprisingly—if it was previously transferred to an already solid state by whichever means. Structures, for example, can be produced that are suited as waveguides.

In a previous or, preferably, subsequent step, the entire material located on the substrate or in the mold is solidified in a preferred, though not the only possible embodiment. This can occur either through irradiation or through heating. If irradiation is used in this step, it preferably occurs with UV light, e.g. in the range of between 200 and 500 nm, very particularly preferably at approx. 365 nm (so-called I line), thus with a roughly doubled energy of the occurring photons, compared with exposure during two-photon polymerization. Thermal solidification occurs preferably at temperatures in the range between 80 and 170° C., wherein the period can be appropriately selected by a specialist depending on the size of the mold and is, e.g. a few seconds to several hours. In one special embodiment, both measures can be combined, wherein the irradiation with UV light is followed by thermal post-hardening. This pre and follow-up treatment assists with the complete hardening so as to ensure that the resulting product also remains stable for long periods of time with respect to optical and mechanical properties. The refractive index difference Δn will in return become smaller in this process, surprisingly however, it remains in a sufficient amount and is not eliminated, although due to the saturation curves of the TPA reaction, we must assume that all organically polymerizable groups—insofar as not sterically hindered in the process—should be fully reacted in both areas.

In all aforementioned embodiments, it is possible that a cross-linking step precedes the selective solidification step. This is beneficial as the selective exposure for producing the areas with, e.g. a higher refractive index, leads to potentially more precise structures due to the fact that diffusion processes and movement processes in the material are attenuated or prevented, which are caused by the selective energy input and/or, if the sample is moved and not only the laser, the motion of the laser during the exposure process. Surprisingly, the inventors were able to determine that this kind of hardening does not prevent or worsen the following selective production of the desired structure. In the process, it is preferred that the cross-link is caused through irradiation in a photochemical manner. The irradiation may occur with the same wavelengths as previously described; the duration lies at less than one second to approx. 60 minutes, wherein particularly a duration of 1 to 360 seconds, here in turn particularly 5 to 60 seconds, is favorable. This fact that is step does not negatively influence the subsequent selective cross-linking of areas treated with 2PP is a complete surprise if we consider that the materials are already fully cross-linked after 1 to 30 seconds (i.e. until “saturation”), as inventors have known for years from their spectroscopic tests.

Specifically, in particular the five defined processes can be described with the aforementioned measures as follows:

In general, the following applies—if the starting material sued is liquid or pasty, it is introduced onto a substrate or into a mold or a bath. In alternative embodiments, the starting material is already solid (some polysiloxanes, e.g. containing styryl groups, are already solid or semi-solid after the complete hydrolytic condensation). In the first case, the application or introduction may occur through any method known in the state of the art, for example, applying a liquid or pasty material through spin-coating, with a squeegee, through dispensing, compression, submersion or spraying, but also through applying or potentially fastening a previously solidified material on or to a substrate or into or in the mold, wherein all conventional substrate and mold materials can be used, such as glass, silicon or metals, and the layer thickness can be selected fully variably, for example, between 100 nm and several mm. The substrate can be planar, but it can also have an uneven form; molded articles of any (even larger) dimension, particularly a relatively high dimension, can be produced, e.g. in the range of 1-10 mm.

### Method 1

In the first step, an ultra-short pulsed laser light focus in produced in the material on the substrate/in the mold by means of a suitable lens. Two-photon polymerization of the starting material located there is achieved in the laser focus. The focus is moved through the material such that the desired volume elements therein are optically polymerized as a result of two-photon or multi-photon polymerization, while the surrounding/adjacent bath material remains unchanged (“laser writing”). After completion of the desired area with TPA or MPA cross-linking, the entire bath will be exposed with UV light in a second step, preferably with a wavelength of 200-500 nm and particularly preferably of 365 nm (I line).

### Method 2

This method comprises both steps of method 1. A third step follows, in which the entire bath material is subjected to thermal energy, for example, in an oven or by placing the bath-filled mold onto a hot plate. The duration of this measure is selected according to need, it will be for a few (e.g. 5) minutes up to several (e.g. 8) hours. In the process, the material can be heated at temperatures of particularly between 80 and 170° C. However, higher temperatures cannot be precluded.

### Method 3

The starting material used is irradiated with light in a first step, preferably with UV light of a wavelength of 200-500 nm, very particularly preferably of 365 nm (I line). The duration of irradiation is surprisingly not critical; it can be, e.g. between 1 and 3600 seconds, i.e. up to beyond the saturation of the TPA reaction. Even longer exposure times cannot be precluded. The second and third steps correspond with the first and second process step of method 1.

### Method 4

The first process step corresponds with the first process step of method 3. The second and third steps correspond with the second (2PP/MPP), and the third process step (thermal hardening) of method 2.

### Method 5

According to this method, the starting material used is completely irradiated with light in a first step—as described for method 3. This is followed by the step involving “laser writing”—as described for method 1. Method 5 differentiates from method 3 by the fact that a subsequent solidification is waived.

In all aforementioned variations, additional mechanical pressure may be applied, which is selected depending on the purpose of the application. For this, for example, a planar substrate can be applied from above onto the surface of the layer subject to the method or of the molded article and the resulting “sandwich” is placed in a press.

Organopolysiloxanes organically cross-linked through two-photon or multi-photon polymerization (2PP, MPP), the organically cross-linked groups of which are components of radicals bonded to silicon via carbon, are preferably duroplastic materials, which are distinguished by a high temperature resistance as well as an excellent temperature-dimensional stability compared to most purely organic polymers.

In a second variation not mentioned above as preferred, the (only) step is or all steps of solidification of the entire material are omitted. Thus, first a solidified structure is obtained through “laser writing”, the outer edges of which are surrounded at least partially by a liquid or pasty starting material. Due to the lacking cross-link, said starting material is dissoluble in many solvents, which specialists are aware of, for example, in alcohols, aqueous alcoholic solutions, ketones or mixtures thereof, and can therefore be washed away in a simple manner. A structured molded article or a structured surface remains. This type of method is particularly suitable for the production of molded articles or surfaces having a sophisticated geometry, which can only be produced with the help of forming methods or with exposure with masks. Examples of these types of molded articles are porous molded articles, particularly with pores in the μm or nm range, which can potentially have a non-straight lined geometry. These molded articles are needed, for example, as scaffolds (to allow living cells to grow).

A variety of inorganically cross-linkable organopolysiloxanes (organo-silicic acid polycondensates) usable pursuant to the invention have a low absorption in the range of wavelengths of interest for data and telecommunications (810 to 1550 nm). These polymers can be obtained, for example, if the condensate only has insignificant shares of SiOH groups or is nearly or completely void thereof. A low absorption can be obtained as well, for example, through the use of starting materials, the carbon-containing groups of which are completely or partially fluorinated. Furthermore, it is, e.g. beneficial for this purpose to maintain the share of SiO groups in the resin, i.e. the “inorganic” share, relatively high. This can be done, for example, by adding silanes to the mixture to be hydrolyzed, which contain no organic groups, but rather can be hydrolyzed on all four radicals, e.g. tetra alkoxysilanes, such as tetraethoxysilane. The materials minimally absorbing light in the respective frequency bands in the range of 810 to 1550 nm enable passive and active optical elements to be inexpensively produced with the help of the method pursuant to the invention, the internal optical surfaces of which are very smooth or refined and precisely structured, such as waveguides, prisms, and micro-lenses or even grates.

As mentioned, resins are materials based on organopolysiloxanes, which can be selected in a vast number and variety with respect to various physical, chemical, and biological properties as they can carry a number of different functional groups, which influence the physical and chemical properties of the resin (e.g. cross-link formations, cross-link converters). Thus, these resins are of particular benefit for application in the designated areas. This applies primarily for the use of femtosecond laser irradiation of silane resins preferred pursuant to the invention.

On one hand, the flexibility of the method and the organopolysiloxanes use therefore and their non-toxicity on the other likewise allow for an application in the area of producing any sophisticated, three-dimensional structures from a virtual model on the computer.

The invention is explained in more detail below based on design examples. It has already been made clear that a number of polysiloxanes are suitable for the invention; as their formulation may in turn vary due to the addition of a number of monomers, the following examples are limited to a select starting material and its modifications; specialists should be aware that they can instead use any of the materials, the manufacturing of which is described, e.g. in the aforementioned printed publications, and this may analogously vary as well.

### 1. Production of the Basic Polysiloxane

For receiving 302.3 g (1.02 mol) of TMPTA in 1020 ml of acetic ester and an ethanol KOH solution, which serves as a catalyst for the thiol addition, 153.3 g (0.85 mol) of 3-Mercaptopropyl methyldimethoxysilane are added drop-wise while cooling and stirred at room temperature. The completion of the reaction (thiol addition) can be determined by means of an iodine-mercaptan test. After adding an aqueous HCl for hydrolysis, stir at room temperature. The course of the hydrolysis is tracked respectively through water titration. Reconditioning occurs after 1 day of stirring by means of solvent extraction with water and filtration through a hydrophobized filter. The solvent is rotated away and subsequently extracted with an oil pump vacuum. This results in a liquid resin having a viscosity of approx. 9 Pas at 25° C. In the next step, 2% by weight of the photoinitiator, with respect to the molar amount of silane used, is then added to the formulation and stirred into the material formulation in the yellow light laboratory. The resulting material is/can then be filtered and is then ready for use for one of the methods for producing products pursuant to the invention.

### 2. Addition of Monomers—General Rule

A molar amount N of a monomer, with respect to the molar amount M of silane, which was used for the production of the basic polysiloxane, is added to the polysiloxane while stirring (normally at ambient pressure and temperature) and continually stirred until the components are mixed homogenously with each other. The molar amount N may vary up to 0.8 mol. The photoinitiator is then added, as explained for the production of the basic polysiloxane.

### 3. Addition of Monomers—Specific Examples

The general rule specified under point 2. was executed with N/M=0.2, wherein the following monomers were used:
MPEG500MA
DDDMA
TEGDMA
C13MA+BED
EMA BED
C13MA
PEG400MA
   4. Production of the Material with Structurally Different Areas

The material was applied to a planar substrate, e.g. a circuit board, through spin-coating in a thickness of 300 to 500 μm and then subjected to “Method 4” above. The exposure period for the step was varied; it was either 180 seconds or 600 seconds, which is equivalent to six times the dose of the energy dose usually used for single-photon processes. Simultaneously, measurements of the refractive index difference Δn (the so-called refraction travel time) were taken prior to and after the third step (thermal cross-linking). The refraction travel times were determined with the RNF method (refractive near field); specialists, however, are familiar with additional methods for determining this parameter. The refractive index of layers or even films can be generally determined, for example, with a prism coupler, an Abbé refractometer or m-line spectroscopy. The travel time of the refractive index of the basic polysiloxane was measured with 0.002 at 850 nm (without thermal cross-linking). Diagram 1 reflects the travel times of the refractive index for the incorporation of the various monomers, wherein TPA represents the two-photon polymerization step and T represents the subsequent temperature treatment; “TPA” alone represents the measurement of the travel time of the refractive index prior to thermal cross-linking, “TPA+T” represents the measurement after thermal cross-linking. We can see that the travel time of the refractive index prior to thermal cross-linking were substantially higher in the first step with an exposure time of 180 seconds than during the exposure period of 600 seconds in the first step. Due to thermal post-cross-linking, the values decreased again and were moreover surprisingly somewhat leveled.

What is claimed is:

1. A layer or three-dimensional molded article comprised of an organically modified polysiloxane or a derivative thereof, the silicon atoms of which are fully or partially replaced by other metal atoms, wherein the organic share of the polysiloxane or derivative thereof has an organic cross-link with (i) C═C addition polymers and/or thiol-ene addition products bonded to silicon and/or to other metal atoms via carbon and/or oxygen, which are obtainable via a two-photon or multi-photon polymerization reaction, as well as with (ii) organic molecules integrated into the organic cross-link copolymerized via C═C double bonds or through a thiol-ene addition to double bonds or to SH groups of an organic radical, wherein the layer or the article has two areas with differing primary and/or secondary structures, available through the following process:
a) Providing a substrate or a mold,
b) Providing a material selected from sols, gels, and organically modified materials containing polysiloxanes, all of which contain metal and/or metalloid, wherein said material has the following components:
(i) At least one oligomer or polymer containing metal or metalloid having groups that are polymerizable via a two-photon or multi-photon polymerization reaction, for which the formation of either C═C addition polymers and/or thiol-ene addition products is possible, wherein at least a part of these groups is present bonded to said oligomers or polymers containing metal or metalloid via a carbon atom or an oxygen bridge, and
(ii) At least one organic monomer containing at least one radical, which is available to either the same two-photon or multi-photon polymerization as the groups of the oligomers or polymers containing metal or metalloid pursuant to (i) or which can be photochemically copolymerized with these radicals or can be added to them,
c) Applying or attaching the provided material on or to the substrate or pouring it into the mold,
d) Selective exposure of a selected area of material located on the substrate or in the mold with the help of two-photon or multi-photon polymerization, and
e) Thermal or photochemical treatment of the entire material located on the substrate or in the mold,
with the provision that steps d) and e) can be conducted in any sequence.

2. A layer or three-dimensional molded article according to claim 1, wherein the material provided according to step (b) comprises an organically modified material containing polysiloxanes, which is obtainable through hydrolysis and at least partial condensation of a starting material containing at least one silane of a formula (I),
R¹ₐR²_{b}SiX_{4-a-b} (I)
wherein R¹ is equal or different and represents an organic radical polymerizable via two-photon or multi-photon polymerization, R² is equal or different and refers to an organic radical not capable of being polymerized in this manner, and X is a radical that can be hydrolyzed out of silicon under hydrolysis conditions, the index a represents 1, 2 or 3, the index b represents 1 or 2, and a+b together are 1, 2 or 3.

3. A layer or three-dimensional molded article according to claim 2, which is obtainable due to said monomer containing at least one radical according to step (b) (ii), selected from radicals, which can be co-polymerized via C═C double bonds bonded or bonded to double bonds or to SH groups of said radical R¹ via a thiol-ene addition, and preferably from radicals R¹ as defined for formula (I).

4. A layer or three-dimensional molded article according to claim 1, wherein the areas with different primary and/or secondary structures have different refractive indices.

5. A layer or three-dimensional molded article according to claim 1, wherein the areas with different primary and/or secondary structures have different cross-linking structures.

6. A layer or three-dimensional molded article according to claim 1, wherein at least the one monomer (ii) is a purely organic polymer.

7. Use of a molded article according to claim 1 as a waveguide.

8. A method for producing a three-dimensional layer or a three-dimensional molded article having two areas with different primary and/or secondary structures, comprising:
a) Providing a substrate or a mold,
b) Providing a material selected from sols, gels, and organically modified materials containing polysiloxanes, all of which contain metal and/or metalloid, wherein said provided material has the following components:
i) At least one oligomer or polymer containing metal or metalloid having groups that are polymerizable via a two-photon or multi-photon polymerization reaction, for which the formation of either C═C addition polymers and/or thiol-ene addition products is possible, wherein at least a part of these groups is present bonded to said oligomers or polymers containing metal or metalloid via a carbon atom or an oxygen bridge, and
(ii) At least one organic monomer containing at least one radical, which is available to either the same two-photon or multi-photon polymerization as the groups of the oligomers or polymers containing metal or metalloid pursuant to (i) or which can be photochemically copolymerized with these radicals,
c) Applying or attaching the provided material on or to the substrate or pouring it into the mold,
d) Selective exposure of a selected area of material located on the substrate or in the mold with the help of two-photon or multi-photon polymerization, and
e) Thermal or photochemical treatment of the entire material located on the substrate or in the mold,
with the provision that steps d) and e) can be conducted in any sequence.

9. A method according to claim 8, wherein the areas with different primary and/or secondary structures have different refractive indices.

10. A method according to claim 8, wherein the areas with different primary and/or secondary structures have different cross-linking structures.

11. A method according to claim 8, wherein the material provided according to step (b) comprises an organically modified material containing polysiloxanes, which is obtainable through hydrolysis and at least partial condensation of a starting material containing at least one silane of a formula (I),
R¹ₐR²_{b}SiX_{4-a-b} (I)
wherein R¹ is equal or different and represents an organic radical polymerizable via two-photon or multi-photon polymerization, R² is equal or different and refers to an organic radical not capable of being polymerized in this manner, and X is a radical that can be hydrolyzed out of silicon under hydrolysis conditions, the index a represents 1, 2 or 3, the index b represents 1 or 2, and a+b together are 1, 2 or 3.

12. A method according to claim 11, wherein the organic monomer contains at least one radical pursuant to step (b) (ii) selected from radicals, which are co-polymerizable via C═C double bonds or can be bonded to double bonds or SH groups of the radical R¹ via thiol-ene addition, and preferably from radicals R¹ as defined for formula (I).

13. A method according to claim 11, wherein R¹ is a radical containing a non-aromatic C═C double bond, preferably a α,β-unsaturated carbonyl compound and/or wherein R² is potentially substituted alkyl, aryl, alkylaryl or arylalkyl, wherein the carbon chain of these radicals can be broken by a coupling group, preferably from among O, S, NH, COHN, COO, NHCOO, and/or wherein X is hydrogen, halogen, hydroxy, alkoxy, acyloxy or NR³₂ with R³ equal to hydrogen or lower alkyl.

14. A method according to claim 11, wherein the starting material still contains at least one additional silane of a formula (II),
SiX₄ (II)
wherein X is equal or different and has the same meaning as in formula (I).

15. A method according to claim 11, wherein the starting material still contains at least one additional silane of a formula (III),
R⁴ₐSi(OH)₄₋ₐ (III)
wherein R⁴ can be equal or different and has either the meaning of R¹ as defined in formula (I) or of R² as defined in formula (I), and wherein the index a represents 1, 2 or 3.

16. A material containing polysiloxane, comprising
a) A polysiloxane that was obtained through hydrolysis and at least partially through condensation of a starting material having or containing at least one silane of a formula (I) or being largely comprised thereof,
R¹ₐR²_{b}SiX_{4-a-b} (I)
wherein R¹ is equal or different and represents an organic radical polymerizable via two-photon or multi-photon polymerization, R² is equal or different and refers to an organic radical not capable of being polymerized in this manner, and X is a radical that can be hydrolyzed out of silicon under hydrolysis conditions, the index a represents 1, 2 or 3, the index b represents 1 or 2, and a+b together are 1, 2 or 3, as well as
b) an organic monomer having either the same radical R¹ as the silane of said formula (I) or containing at least one radical, organic monomer, selected among radicals having monomeric organic molecules, which are co-polymerizable via C═C double bonds or capable of being bonded into the organic cross-link through thiol-ene addition to double bonds or to SH groups of the radical R¹.

17. A material containing polysiloxane according to claim 16 in the form of a porous molded article, particularly a molded article with pores in the μm or nm range and/or a molded article suitable as a scaffold.

18. A method for producing a three-dimensional layer or a three-dimensional molded article including the material containing polysiloxane according to claim 15, comprising:
a) Providing a substrate or a mold,
b) Providing a material selected from sols, gels, and organically modified materials containing polysiloxanes, all of which contain metal and/or metalloid, wherein said provided material has the following components:
i) At least one oligomer or polymer containing metal or metalloid having groups that are polymerizable via a two-photon or multi-photon polymerization reaction, for which the formation of either C═C addition polymers and/or thiol-ene addition products is possible, wherein at least a part of these groups is present bonded to said oligomers or polymers containing metal or metalloid via a carbon atom or an oxygen bridge, and
(ii) At least one organic monomer containing at least one radical, which is available to either the same two-photon or multi-photon polymerization as the groups of the oligomers or polymers containing metal or metalloid pursuant to (i) or which can be photochemically copolymerized with these radicals, (ii)
c) Applying or attaching the provided material on or to the substrate or pouring it into the mold,
d) Selective exposure of a selected area of material located on the substrate or in the mold with the help of two-photon or multi-photon polymerization, and
e) Separating the molded article from non-exposed material by washing the article in a solvent, in which the provided material dissolves pursuant to step (b).

19. A method according to claim 18, wherein the material provided pursuant to step (b) comprises an organically modified material containing polysiloxane, which is obtainable through hydrolysis and at least partially through condensation of a starting material having or containing at least one silane of a formula (I) or being largely comprised thereof,
R¹ₐR²_{b}SiX_{4-a-b} (I)
wherein R¹ is equal or different and represents an organic radical polymerizable via two-photon or multi-photon polymerization, R² is equal or different and refers to an organic radical not capable of being polymerized in this manner, and X is a radical that can be hydrolyzed out of silicon under hydrolysis conditions, the index a represents 1, 2 or 3, the index b represents 1 or 2, and a+b together are 1, 2 or 3.

20. A method according to claim 19, wherein the organic monomer contains at least one radical pursuant to step (b) (ii) selected from radicals, which are co-polymerizable via C═C double bonds or can be bonded to double bonds or SH groups of the radical R¹ via thiol-ene addition, and preferably from radicals R¹ as defined for formula (I).

21. A method according to claim 19, wherein R¹ is a radical containing a non-aromatic C═C double bond, preferably a α,β-unsaturated carbonyl compound and/or wherein R² is potentially substituted alkyl, aryl, alkylaryl or arylalkyl, wherein the carbon chain of these radicals can be broken by a coupling group, preferably from among O, S, NH, COHN, COO, NHCOO, and/or wherein X is hydrogen, halogen, hydroxy, alkoxy, acyloxy or NR³₂ with R³ is equal to hydrogen or lower alkyl.

22. A method according to claim 19, wherein the starting material still contains at least one additional silane of a formula (II),
SiX₄ (II)
wherein X is equal or different and has the same meaning as in formula (I).

23. A method according to claim 19, wherein the starting material still contains at least one additional silane of a formula (III),
R⁴ₐSi(OH)₄₋ₐ (III)
wherein R⁴ can be equal or different and has either the meaning of R¹ as defined in formula (I) or of R² as defined in formula (I), and wherein the index a represents 1, 2 or 3.

24. A method according to claim 19 for producing a porous molded article, particularly a molded article with pores in the μm or nm range and/or a molded article suitable as a scaffold.
